(19) United States
(12) Patent Application Publication
(10) Pub. No.: US 2005/0100369 A1
(43) Pub. Date: May 12, 2005

(54) Image forming apparatus and a control method thereof

(75) Inventors: Moon-bae Park, Suwon-si (KR); Cheol-ju Yang, Dalsco-gu (KR); Su-kyoung Chae, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/981,605

(22) Filed: Nov. 5, 2004

(30) Foreign Application Priority Data
Nov. 12, 2003 (KR) 2003-79798
Mar. 29, 2004 (KR) 2004-21190

(51) Int. Cl. G03G 15/01

(52) U.S. Cl. 399/302

(57) ABSTRACT

An image forming apparatus and control method which use an intermediate transfer medium to transfer an image developed on an organic photoconductive medium onto a paper, and clean a surface of the intermediate transfer medium using a cleaning blade are provided. The apparatus and control method comprise driving the organic photoconductive medium and the intermediate transfer medium together with each other during a warming-up mode; stopping the organic photoconductive medium and the intermediate transfer medium until a print command is input during a stand-by mode; printing the developed image onto the paper sheet using the intermediate transfer medium in response to the print command; and reducing a friction between the intermediate transfer medium and the cleaning blade.

### CROSS-REFERENCE TO RELATED APPLICATIONS

This application claims the benefit under 35 U.S.C. 119(a) of Korean Patent Application Nos. 2003-79798, filed on Nov. 12, 2003, and 2004-21190, filed on Mar. 29, 2004, in the Korean Intellectual Property Office, the entire contents of which are incorporated herein by reference.

### BACKGROUND OF THE INVENTION

1. Field of the Invention

The present invention relates to a control method of an image forming apparatus. More particularly, the present invention relates to an image apparatus and method for preventing a cleaning blade in the image forming apparatus from being warped or bent.

2. Description of the Related Art

An image forming apparatus such as a laser color printer comprises an organic photoconductive drum on which an image is developed, and an intermediate transfer belt for transferring the developed image from the organic photoconductive drum onto paper. Respective color developing units are disposed around the organic photoconductive drum to develop the image formed on the organic photoconductive drum to a color image using the colors of yellow, magenta, cyan, and black, preferably in that order. The intermediate transfer belt operates in contact with the organic photoconductive drum, and the respective developed color images overlap on the intermediate transfer belt, so that a desired colored image can be obtained. The final overlapping color images are transferred onto the paper which is moving in contact with the intermediate transfer belt.

A cleaning blade is disposed in contact with the intermediate transfer belt at a predetermined angle, for removing fine toner particles that have not been transferred to the paper and still remain on the intermediate transfer belt.

The organic photoconductive drum and the intermediate transfer belt are controlled such that they simultaneously rotate in contact with each other. That is, they rotate together with each other during the printing operation as well as the initial warming-up period. Also, in a density measurement mode for measuring the density of the developed color image in the middle of printing, the organic photoconductive drum and the intermediate transfer belt rotate together.

During the printing operation, the cleaning blade can maintain a constant position due to less friction occurring between the cleaning blade and the intermediate transfer belt because some toner remains on the intermediate transfer belt. However, during the warming-up period or the density measurement mode, because there is no toner on the intermediate transfer belt, much more friction is being exerted between the cleaning blade and the intermediate transfer belt. Due to the friction, the cleaning blade may be warped or bent, and this causes changes in a contact angle between the cleaning blade and the intermediate transfer belt. Consequently, satisfactory cleaning with respect to a surface of the intermediate transfer belt may not be achieved. In this case, the remaining toner may be transferred to the color image on the paper, which causes image degradation such as a blurred image.

### SUMMARY OF THE INVENTION

The present invention has been developed in order to solve the above problem in the related art. Accordingly, an aspect of the present invention is to provide an image forming apparatus and a control method for preventing a cleaning blade from being warped or bent in the image forming apparatus.

The above aspect is achieved by providing a control method of an image forming apparatus, which uses an intermediate transfer medium for transferring an image developed on an organic photoconductive medium onto a paper, and cleans a surface of the intermediate transfer medium using a cleaning blade. The control method comprises driving the organic photoconductive medium and the intermediate transfer medium together with each other during a warming-up mode; stopping the organic photoconductive medium and the intermediate transfer medium until a print command is input during a stand by mode; printing the developed image onto the paper sheet using the intermediate transfer medium in response to the print command; and reducing a friction between the intermediate transfer medium and the cleaning blade.

The step of reducing the friction further comprises lubricating between the cleaning blade and the intermediate transfer medium during the warming-up mode by forming a predetermined image pattern for lubricating the intermediate transfer medium and removing the image pattern using the cleaning blade.

The lubricating step further comprises developing the image pattern for lubrication on the organic photoconductive medium during the warming-up mode; transferring the image pattern from the organic photoconductive medium to the intermediate transfer medium; and removing the transferred image pattern using the cleaning blade.

The image pattern for lubrication maybe a toner image having a lower density than a standard image.

The image pattern for lubrication may be formed on an entire image area of the intermediate transfer medium.

The control method further comprises checking a density of the image formed on the organic photoconductive medium after a predetermined number of sheets has been printed. The step of reducing the friction further comprises performing a first lubrication for forming an image pattern for lubricating the intermediate transfer medium and removing the image pattern using the cleaning blade during the warming-up mode; and performing a second lubrication after the printing of the predetermined number of sheets to measure the density, forming an image pattern for lubricating the intermediate transfer medium and removing the image pattern using the cleaning blade.

The first and the second steps of lubrication, respectively, comprise steps of: developing the image pattern for lubrication on the organic photoconductive medium; transferring the developed image pattern to the intermediate transfer medium; and removing the image pattern using the cleaning blade.

### BRIEF DESCRIPTION OF THE DRAWING FIGURES

The above aspects and other advantages of the present invention will be more apparent by describing an embodiment of the present invention with reference to the accompanying drawing figures, in which:

FIG. 1 is a view schematically illustrating an image forming apparatus according to an embodiment of the present invention to explain to a control method thereof; and

FIG. 2 is a flowchart illustrating a process for preventing a cleaning blade from being warped or bent in the image forming apparatus according to an embodiment of the present invention.

In the drawing figures, it should be understood that like reference numerals refer to like features and structures.

### DETAILED DESCRIPTIONS OF AN EXEMPLARY EMBODIMENT

An image forming apparatus and a control method for preventing a cleaning blade from being warped or bent in the image forming apparatus according to an embodiment of the present invention will now be described in detail with reference to the accompanying drawing figures.

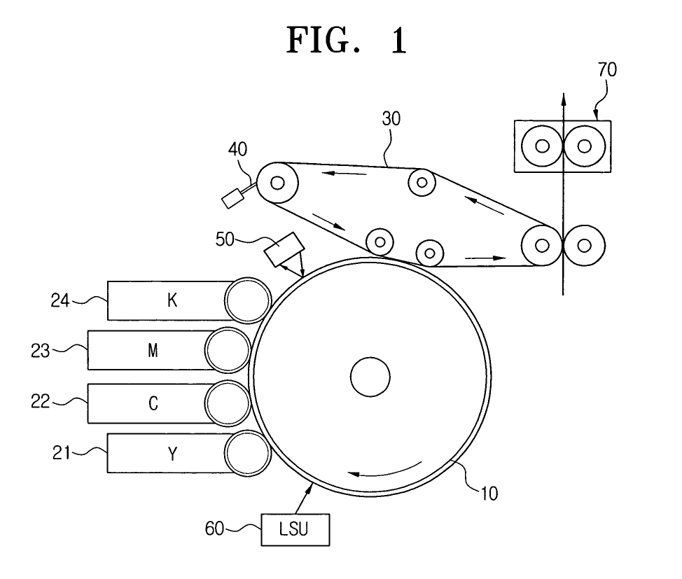

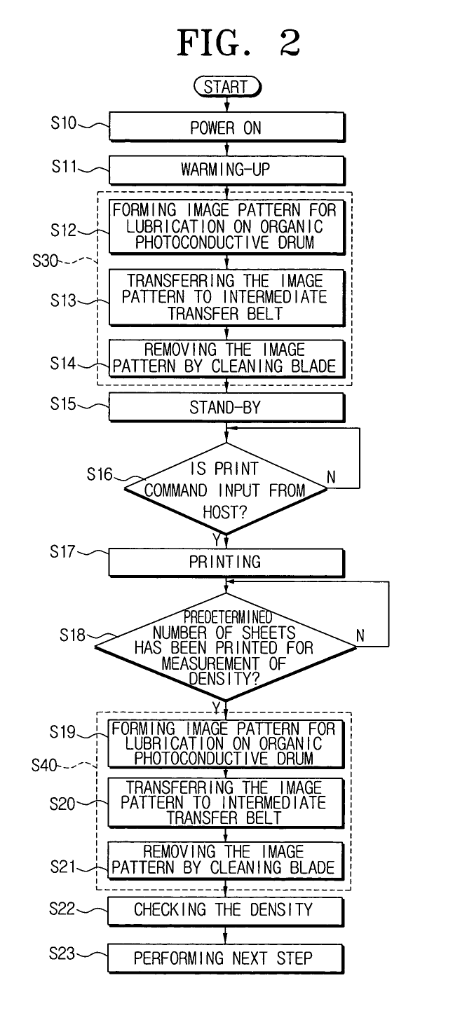

FIG. 1 is a view schematically illustrating a laser color printer as one example of an image forming apparatus according to an embodiment of the present invention to explain a control method thereof. FIG. 2 is a flowchart illustrating a process for preventing a cleaning blade from being warped or bent in the image forming apparatus according to an embodiment of the present invention.

Referring to FIGS. 1 and 2, a laser color printer comprises an organic photoconductive drum 10 on which an image is developed, a plurality of developing units 21, 22, 23, and 24 for developing the image formed on the organic photoconductive drum 10 into a color image, an intermediate transfer belt 30 operating in contact with the organic photoconductive drum 10, a cleaning blade 40 for cleaning a surface of the intermediate transfer belt 30, and a density sensor 50 for measuring a density of the developed color image on a surface of the organic photoconductive drum 10.

The organic photoconductive drum 10 rotates in one direction and forms thereon a predetermined color image through a procedure of discharging, charging, laser scanning, and developing. Such a color image forming procedure is well-known, and thus, detailed descriptions thereof are omitted. In the figure, the laser color printer further comprises a laser scanning unit 60 for scanning the surface of the organic photoconductive drum 10 with laser beams.

The respective color developing units 21, 22, 23, 24 overlaps color images over on the organic photoconductive drum 10 in a predetermined order. The color developing units 21, 22, 23, and 24 are attachable to and separable from the organic photoconductive drum 10. The organic photoconductive drum 10 is designed to rotate at least four times to obtain one desired color image.

The intermediate transfer belt 30 transfers the developed color image from the organic photoconductor 10 onto paper P. The transferred color image is fused onto the paper P by passing through a fusing unit 70.

The cleaning blade 40 removes fine toner particles which have not been transferred onto paper P and still remain on the intermediate transfer belt 30. To remove the fine toner particles, the cleaning blade 40 is disposed in contact with the intermediate transfer belt 30 at a predetermined angle. The cleaning blade 40 comprises a thin film or a resilient material.

The density sensor 50 measures a density of the developed color image on the organic photoconductor 10, and typically uses a light receiving and emitting sensor. The density sensor 50 is controlled by a controller (not shown) such that it detects whether the color image has developed correctly after a predetermined number of sheets has been printed. For example, if the number of sheets to be printed is set to 100 sheets, the density sensor 50 checks the density of the color image in every one-hundredth (100^{th}) paper sheet. Based on the result of the checking, the laser color printer performs an appropriate next procedure.

A control method of the image forming apparatus with the above construction will now be described with reference to FIG. 2.

A power is supplied to power on the image forming apparatus at step S10. The controller rotates the organic photoconductive drum 10 and the intermediate transfer belt 30 a predetermined number times in a warming-up mode at step S11. In order to reduce friction between the intermediate transfer belt 30 and the cleaning blade 40 during the warming-up mode, a first lubricating operation is performed at step S30. More specifically, the first lubricating step S30 comprises forming an image pattern for lubricating the organic photoconductive drum 10 through a well-known developing process at step S12. The image pattern for lubricating is transferred to the intermediate transfer belt 30 at step S13. Then, the transferred image pattern is removed from the intermediate transfer belt 30 using the cleaning blade 40 which contacts the intermediate transfer belt 30 at step S14. Through the steps of transferring the image pattern for lubrication onto the intermediate transfer belt 30 and removing the image pattern from the intermediate transfer belt 30, the friction between the cleaning blade 40 and the intermediate transfer belt 30 is reduced. Accordingly, the cleaning blade 40 can be prevented from being warped or bent. The first lubricating step at step S30) continues until the warming-up mode is complete.

When the first lubricating step at step S30 and the warming-up mode at step S11 are complete, the organic photoconductive drum 10 and the intermediate transfer belt 30 are stopped and maintained in a standby mode at step S15. In the standby mode at step S15, if a print command is input from a host at step S16, input print data are processed such that a printing operation is performed at step S17. The printing operation at step S17 is performed through a well-known process, and thus description thereof is omitted.

During the printing operation at step S17, the controller counts the number of printed paper sheets in order to measure the density of the developed image on the organic photoconductive drum 10 at step S18. because the continuous printing operation causes changes in the characteristics of the organic photoconductive drum 10 and the developing units 21, 22, 23, and 24, and thus, the density of the images deviates from a reference value. Accordingly, the density sensor 50 checks the density in every predetermined Nth paper sheet. For example, if the predetermined number of sheets is set to 100 sheets, the density is measured in every one-hundredth sheet.

If it is determined that the predetermined number of sheets has been printed at step S18, a second lubricating process is performed with respect to the intermediate transfer belt 30 at step S40. That is, during the idle rotation of the organic photoconductive drum 10 and the intermediate transfer belt 30 in checking the density, it is required that the friction between the cleaning blade 40 and the intermediate transfer belt 30 be reduced. The steps of S19, S20, and S21 are the same as the above sub-steps of S30 are used to form an image pattern for providing lubrication on the organic photoconductive drum 10, transferring the image pattern onto the intermediate transfer belt 30, and removing the image pattern by using the cleaning blade 40. During these processes, the density sensor 50 checks a reflectivity of the organic photoconductive drum 10 and the density of the developed image at step S22. Next, according to the result of checking the density, the density is compensated for or a next step such as a printing is performed at step S23.

According to the control method of the image forming apparatus as described above, the image pattern for lubrication is formed on the intermediate transfer belt 30 during the idle rotations of the organic photoconductive drum 10 and the intermediate transfer belt 30, thereby reducing the friction between the cleaning blade 40 and the intermediate transfer belt 30. Accordingly, the cleaning blade 40 can be prevented from being warped or bent, which may be a result of the increased friction.

1. A control method of an image forming apparatus, which uses an intermediate transfer medium to transfer an image developed on an organic photoconductive medium onto a paper, and cleans a surface of the intermediate transfer medium using a cleaning blade, the method comprising:
driving the organic photoconductive medium and the intermediate transfer medium together with each other during a warming-up mode;
stopping the organic photoconductive medium and the intermediate transfer medium until a print command is input during a stand-by mode;
printing the developed image onto the paper using the intermediate transfer medium in response to the print command; and
reducing a friction between the intermediate transfer medium and the cleaning blade.

2. The control method as claimed in claim 1, wherein the step of reducing the friction further comprises:
lubricating between the cleaning blade and the intermediate transfer medium during the warming-up mode by forming a predetermined image pattern for providing lubrication onto the intermediate transfer medium and removing the image pattern using the cleaning blade.

3. The control method as claimed claim 2, wherein the lubricating step further comprises:
developing the image pattern for lubrication on the organic photoconductive medium during the warming-up mode;
transferring the image pattern from the organic photoconductive medium onto the intermediate transfer medium; and
removing the transferred image pattern via the cleaning blade.

4. The control method as claimed in claim 2, wherein the image pattern for lubrication is a toner image having a lower density than a standard image.

5. The control method as claimed in claim 3, wherein the image pattern for lubrication is a toner image having a lower density than a standard image.

6. The control method as claimed in claim 2, wherein the image pattern for lubrication is formed on an entire image area of the intermediate transfer medium.

7. The control method as claimed in claim 3, wherein the image pattern for lubrication is formed on an entire image area of the intermediate transfer medium.

8. The control method as claimed in claim 1, further comprising:
checking a density of the image formed on the organic photoconductive medium after a predetermined number of sheets has been printed.

9. The control method as claimed in claim 1, wherein the step of reducing the friction further comprises:
a first lubricating step of forming an image pattern for providing lubrication onto the intermediate transfer medium and removing the image pattern via the cleaning blade during the warming-up mode; and
a second lubricating step of, after printing the predetermined number of sheets in order to measure the density, forming an image pattern for providing lubrication onto the intermediate transfer medium and removing the image pattern via the cleaning blade.

10. The control method as claimed in claim 9, wherein the first and the second lubricating steps, respectively, further comprise:
developing the image pattern for lubrication on the organic photoconductive medium;
transferring the developed image pattern to the intermediate transfer medium; and
removing the image pattern via the cleaning blade.

11. An image forming apparatus for using an intermediate transfer medium to transfer an image developed on an organic photoconductive medium onto a paper, and clean a surface of the intermediate transfer medium using a cleaning blade, comprising:
a controller adapted to drive the organic photoconductive medium and the intermediate transfer medium together with each other during a warming-up mode, stop the organic photoconductive medium and the intermediate transfer medium until a print command is input during a stand-by mode, print the developed image onto the paper using the intermediate transfer medium in response to the print command; and reduce a friction between the intermediate transfer medium and the cleaning blade.

12. The apparatus as claimed in claim 11, wherein the controller is further adapted to lubricate between the cleaning blade and the intermediate transfer medium during the warming-up mode by forming a predetermined image pattern for providing lubrication onto the intermediate transfer medium and remove the image pattern using the cleaning blade.

13. The apparatus as claimed in claim 12, wherein the controller is further adapted to develop the image pattern for lubrication on the organic photoconductive medium during the warming-up mode, transfer the image pattern from the organic photoconductive medium onto the intermediate transfer medium; and remove the transferred image pattern via the cleaning blade.

14. The apparatus as claimed in claim 12, wherein the image pattern for lubrication is a toner image having a lower density than a standard image.

15. The apparatus as claimed in claim 13, wherein the image pattern for lubrication is a toner image having a lower density than a standard image.

16. The apparatus as claimed in claim 12, wherein the image pattern for lubrication is formed on an entire image area of the intermediate transfer medium.

17. The apparatus as claimed in claim 13, wherein the image pattern for lubrication is formed on an entire image area of the intermediate transfer medium.

18. The apparatus as claimed in claim 11, the controller is further adapted to check a density of the image formed on the organic photoconductive medium after a predetermined number of sheets has been printed.
